(19) United States
(12) Patent Application Publication
(10) Pub. No.: US 2006/0051725 A1
(43) Pub. Date: Mar. 9, 2006

(54) Magnetic art toy

(76) Inventors: Robert J. Buccella, Woodlyn, PA (US); Gerald W. Cummings, Marlton, NJ (US)

Correspondence Address: NOTARO AND MICHALOS, 100 DUTCH HILL ROAD, SUITE 110, ORANGEBURG, NY, 10962-2100, US

(21) Appl. No.: 10/936,306

(22) Filed: Sep. 8, 2004

(51) Int. Cl. G09B 11/04

(52) U.S. Cl. 434/88

(57) ABSTRACT

A drawing and tracing toy includes a case with a rear wall attached to a frame. A transparent front cover is encased within the frame. A transparent game board with recesses is interposed in between the rear wall and the front cover. A storage compartment lies adjacent to the game board. Play pieces may stored in the storage compartment and moved to the game board via a magnetic tool. A slot is provided on the side of the frame and allows a drawing to be inserted below the game board so that the outline of the drawing can be traced with play pieces on the game board. The case may be locked so that the play pieces do not fall out of the recesses or the storage compartment if the case lies vertically. In locked position, the toy may stand upright via an easel.

### FIELD AND BACKGROUND OF THE INVENTION

The present invention relates generally to the field of toys and in particular to a toy for tracing an image or pattern by manipulation and arrangement of toy pieces on a grid, and vertically displaying the arrangement.

Toys and games which involve manipulation of material by a magnet or arrangement of the material on a game board are known in the art.

U.S. patent Ser. No. 611,545 to Yarnall discloses a toy consisting of a case with separate tracing and magnetic manipulation areas. The case secures two panes of glass separated by a cross-rail. One glass pane is transparent and one is frosted. A platform for supporting magnetized objects, such as letters, figurines and shapes is provided below the transparent glass pane. A carrier is provided within the case and displays pictures or material through the frosted pane. A tracing can be made of the picture on the frosted pane. The magnetized objects may then be manipulated and arranged to describe the picture.

U.S. Pat. No. 3,032,926 to Lang teaches a magnetic picture toy comprising a panel on which pictures are printed, and a transparent plastic blister slidably mounted over the panel so as to cover the pictures. The transparent blister also contains magnetic particles. A magnet is used to position the magnetic particles relative to the picture covered by the transparent plastic blister. The Lang '926 patent does not teach a case with one transparent barrier overlying another in a spaced apart fashion, or recesses for receiving magnetized play pieces.

U.S. Pat. No. 1,549,197 to Hanback teaches a magnetic toy comprising duplicate cases connected via a hinge. Each case includes a base, a frame and a transparent cover where the base and cover are spaced apart due to the frame. Figures are encased within the frame. A magnet is used to manipulate magnetic material within the toy to decorate the encased figures. The '197 patent further discloses that it may be left up to the imagination of the player to produce an entire figure by the use of the magnetic material.

U.S. Pat. No. 2,853,830 to Herzog teaches a magnetic toy that includes a base having a portion enclosed by a transparent plastic cover, a means for sealing the cover to the base, and loose magnetic particles confined in the enclosed portion of the base. A magnetic wand is adapted to move over the outer surface of the cover to collect and deposit batches of magnetic particles within the enclosed portion of the base. A cellophane sheet is placed directly over the cover to minimize static electricity.

U.S. Pat. No. 4,349,201 to Clark teaches a magnetic game that includes a container having a transparent dome cover, a base with pylons containing ball receiving pockets, loose magnetic balls within the container, and a handheld magnet for manipulating the balls over the ball receiving pockets.

U.S. Pat. No. 2,590,002 to Frazier discloses a game device with a hand magnet, an inclined play surface having at selected locations concave play piece receiving pockets, a plurality of hollow, magnetic and non-magnetic semi-spherical play pieces with convex surfaces, and a cover overlying the inclined play surface. The magnet is used above the cover to move the magnetic and non-magnetic pieces for rolling and sliding movement on the surface relative to the pockets.

U.S. Pat. No. 3,883,988 to Fields teaches a transparent container that encloses a plurality of color-coated small magnetized elements which can be maneuvered or manipulated within the container via a bar magnet outside the container. The magnet is tethered to the container.

U.S. Reissue Patent 33,363 teaches a vertically supported magnetic apparatus comprising an enclosure, a transparent face panel and a mixture of non-magnetic particles and magnetized attractive particles contained within the enclosure. The mixture is arranged on the inner surface of the transparent face panel by pivoting the apparatus. A magnet is then moved on the outer surface of the transparent face panel attracting the magnetic particles and dislodging the non-magnetic particles, thus creating a design or image along the path of movement.

Tracing devices are also well known. For example, U.S. Pat. No. 2,427,612 to Lobb teaches a tracing device comprising a box, a rectangular aperture on the front face of the box, a translucent window panel within the aperture, and a card with a picture housed behind the window panel and pressed against the rear face of the window panel via a guiding strip and springs.

Typical easels or vertical supports for drawing boards are taught by U.S. Pat. No. 2,418,296 to Austin, U.S. Pat. No. 4,226,029 to McGuire, and U.S. Pat. No. 4,098,009 to Flynn.

Using playing pieces on a game board to create an image is known from U.S. Pat. No. 3,191,937 to Kropinski. Playing pieces of various colors are selectively disposed or arranged in recesses of a game board to create a composite figure. However, the playing pieces are not magnetized.

Boards or cases having an array of recesses are illustrated in U.S. Patent Des. 359,526 to Kenning, U.S. Patent Des. 300,937 to Yabushita, U.S. Patent Des. 453,537 to Shoptaugh, U.S. Patent Des. 256,140 to Riley and U.S. Patent Des. 247,441 to Kroll.

Drawing devices that involve manipulation of pieces fail to provide a tracing feature. Therefore, such drawing devices are difficult to use for younger children, or require dexterity, skill and imagination that some children do not have. Such drawing devices therefore fail as educational tools as well because a child does not have a guide for learning to draw a particular image. As a result, children lose interest in such drawing devices.

Furthermore, such drawing devices are typically erasable by manipulating the board so that the pieces become dislodged from recesses on the board. Therefore, such a drawing may be accidentally erased by holding the board vertically or completely inverting the board. Such drawing devices cannot be displayed vertically, and require extra care to avoid inadvertent erasure.

Finally, such drawing devices are typically held on the lap of a user and do not have any support.

These problems and deficiencies are solved by the present invention in the manner described below.

### SUMMARY OF THE INVENTION

It is an object of the present invention to provide a drawing toy in which drawing pieces can be manipulated and arranged on a board while simultaneously using a pattern or image as a tracing template beneath the drawing area.

It is a further object of the present invention to provide a semi-permanent drawing board for vertically displaying a drawing made from the arrangement of drawing pieces on a board.

It is another object of the invention to provide a storage area for the drawing pieces which is separate from the drawing board area, but readily accessible.

Finally, it is an object of the present invention to provide a support for a drawing board.

Accordingly, a magnetic toy is provided that includes a game case, a magnetic tool tethered to the case by a break-away lanyard, and an easel on the back of the game case. The game case comprises a rear wall, a front transparent cover, a transparent board with an array of recesses between the rear wall and front cover, and a supply tray adjacent the transparent board. The transparent board and supply tray are spaced apart from the rear wall and front cover. The case further includes a locking mechanism for pushing the transparent board against the front cover, so that game pieces are locked in the game board recesses. A slot on the side of the case permits a picture or design on a sheet of paper to be placed beneath the transparent board.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a perspective view of the case of the present invention;

FIG. 2 is a cross-section view of the case of the present invention;

FIG. 3 is a perspective of a magnetic toy.using the case of the present invention;

FIG. 4 is a rear view of a case with an easel back; and

FIG. 5 is a front view of a case supported by an easel;

### DESCRIPTION OF THE PREFERRED EMBODIMENTS

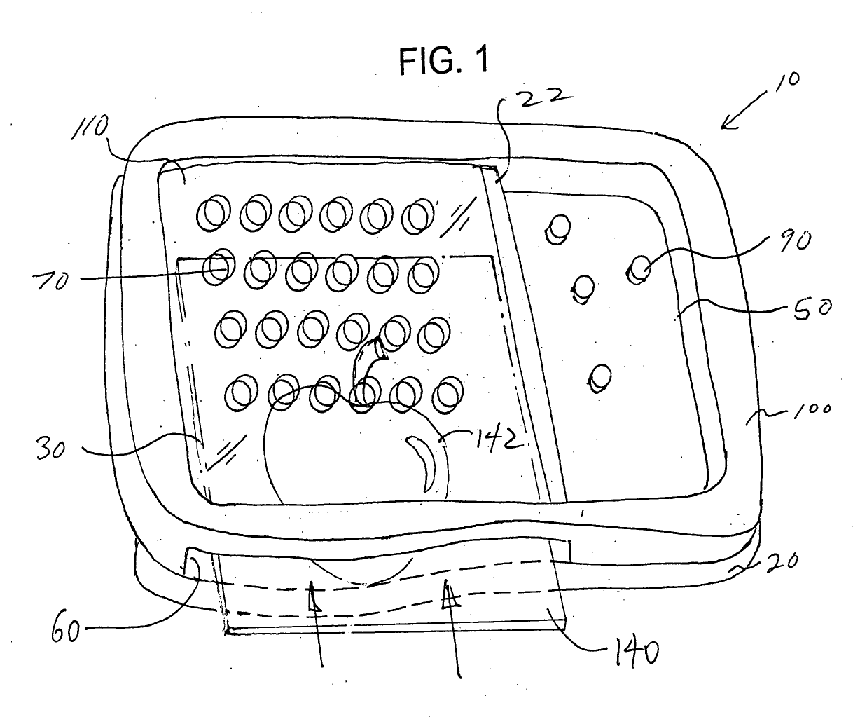

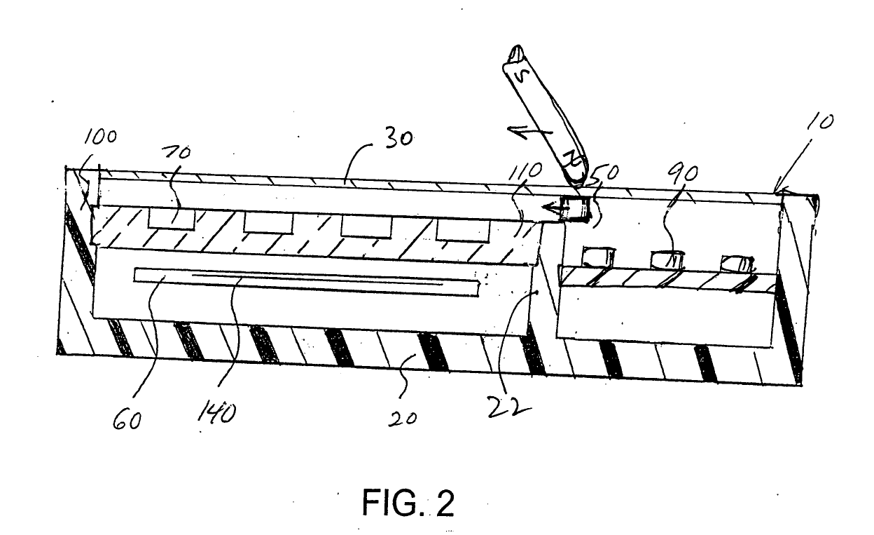

Referring now to the drawings, in which like reference numerals are used to refer to the same or similar elements, FIGS. 1 and 2 show a toy comprising a case generally designated 10. The case 10 is constructed of a rear wall 20 attached to a frame 100. A transparent front cover 30 is connected to the frame 100 and covers the case. A transparent game board 110 and a storage compartment 50 lie adjacent each other between the front cover 30 and rear wall 20. The transparent game board 110 comprises a plurality of recesses 70 on its top surface. The toy also includes a plurality of play pieces 90 which have a geometry, shape, and size that allows them to fit into the recesses of the game board.

The rear wall 20 of the case is attached to the frame at a plurality of points near the edges of the case. The rear wall 20 can be attached to the frame by any means known by one skilled in-the art, such as for example, screws, glue, etc. The game board 110 and storage compartment 50 lie adjacent each other and between the cover 30 and rear 20, as two separate compartments separated by a wall 22. Both compartments have outer walls which conform to the shape of the case. Both the transparent game board 110 and the adjacent storage compartment are spaced apart from the front cover 30 above, and the rear wall 20 below. The space between the game board 110 and rear wall 20 is accessible from the exterior of the case via a slot 60 on the side of the case. The space between the toy board and front cover allows for pieces stored in the storage compartment to be transferred to the adjacent game board 110.

In use, a drawing on a sheet of paper, transparency, film, or similar medium 140 (e.g., an apple 142 in FIG. 1) is provided between the transparent board and the rear wall, via the slot 60 as shown in FIG. 2. The drawing can be seen through the transparent game board 110 and front cover 30. FIG. 1 shows the medium 140 as it is slid into slot 60.

The play pieces 90 are stored in the storage compartment when not in use. The play pieces 90 preferably conform to the shape of the recesses 70 of the game board 110. The play pieces 90 are preferably oval or elliptical, and can fit in round recesses 70. The play pieces 90 are also preferably painted different colors, but may also have designs or letters or painted on the face of the pieces. The play pieces 90 may be made of plastic, metal, or other similar materials.

The case 10 may come in a variety of shapes and sizes. FIG. 1 shows an exemplary case that has an overall rectangular shape with concave sides along the length of the case and convex sides along the width of the case. The case 10 may also have different colors, themes, or designs along the upper frame 100 or the exterior face of the rear wall 20. The case 10 may be made of a variety of materials, but is preferably made of a plastic, which can easily be molded into the appropriate shape and which is cost-effective. Similarly, the transparent game board and storage compartment are also made of a plastic for cost efficiency and ease of production.

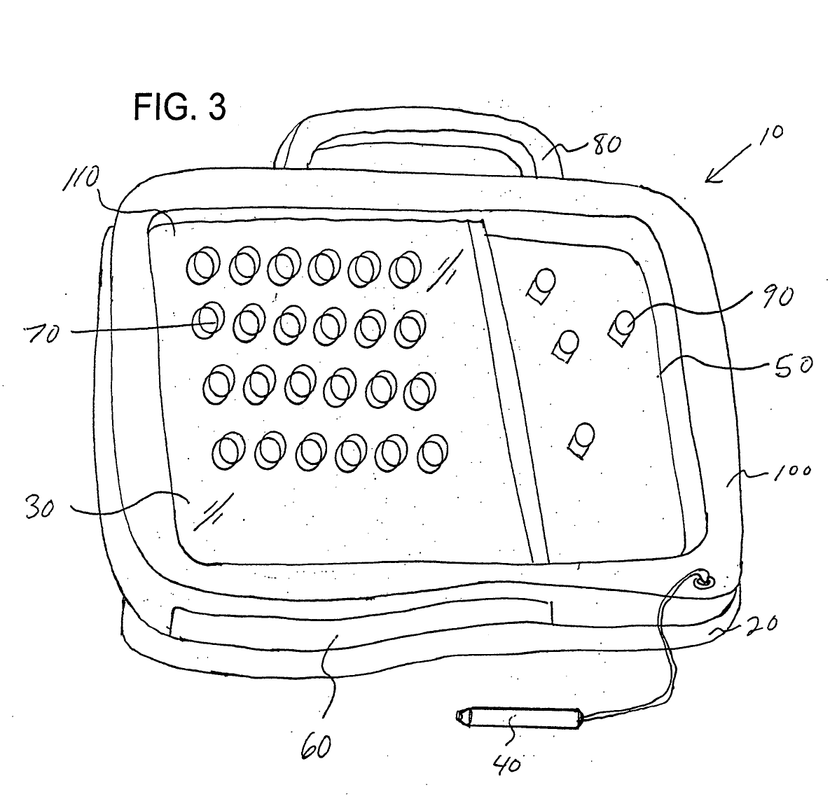

In a second embodiment of the present invention, a magnetic tool is used in combination with case 10 and play pieces 90. FIG. 3 shows a magnetic tool 40 tethered to a case 10. The magnetic tool comprises a magnet and may be in various shapes or forms, such a crayon, pen, stylus, etc. The play pieces are preferably magnetic so that they can be manipulated by the magnetic tool. FIG. 3 also shows an optional handle 80 attached to the case, which can be used for holding and carrying the case. The magnetic tool may be detachable or not attached to the case 10 at all.

In use, the magnetic tool is positioned against the top surface of the transparent front cover 30 (see FIG. 2), above the storage compartment 50, to attract a play piece 90. The play piece 90 attaches to the bottom surface of the cover 30 immediately below the magnetic tool. The magnetic tool is then moved along the cover 30 and over the low wall 22 until it is above the game board 110. The attraction of the play piece 90 to the magnetic tool correspondingly moves the play piece 90 to the game board 110. The user then selects a recess in the game board 110 in which the play piece 90 will be dropped. Removing the magnetic tool from the cover 30 and away from the play piece 90 causes the attraction between the magnetic tool and play piece to be lost and the play piece drops into the preselected recess of the game board 110. Recesses can be preselected to trace an outline or shape of a drawing that is provided below the transparent game board 110 via the slot 60.

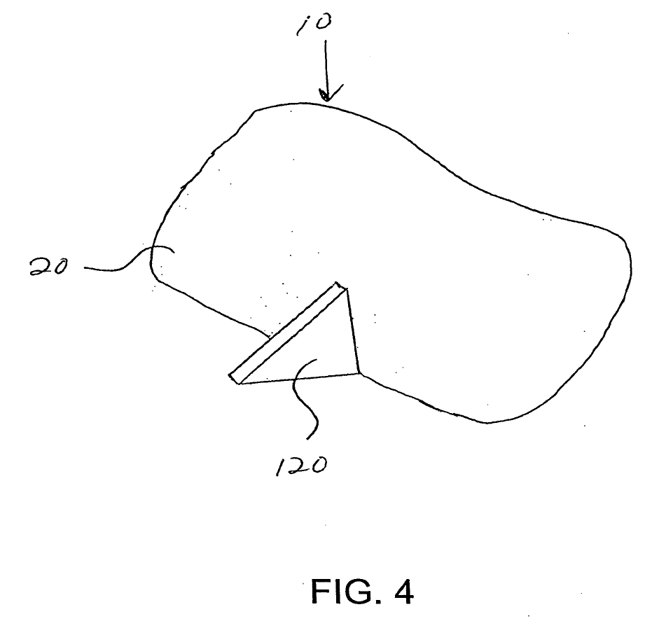

FIG. 4 shows the case supported by an easel back 120. The easel back engages the back of the rear wall of the case, allowing the case to be displayed as a free standing object. The easel back thereby allows any drawings made on the drawing board to be displayed free standing. The easel back is preferably made of wood and is in the shape of a triangle. The easel back can easily slide into a slot on the back of the case, or can be permanently attached to the back of the case. Alternatively, the easel back may fold out via a hinge.

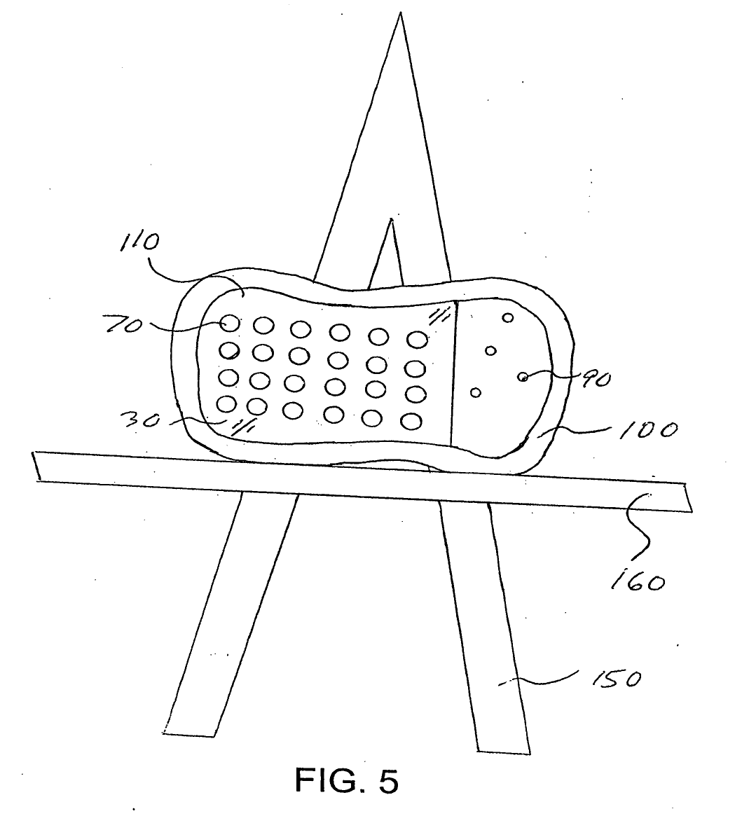

Other conventional types of easels may also be used to support the case of the present invention as shown in FIG. 5. FIG. 5 shows an easel with legs 150 and a support 160 for supporting and displaying the case 10 of the present invention.

The case 10 may have a locking means so that the pieces from the game board will not fall out if the case is inverted or is arranged vertically. Likewise, pieces lying in the storage compartment will not be transferred to the game board inadvertently if the case is inverted or arranged vertically. A switch on the side of the case can be used to activate the locking means.

While a specific embodiment of the invention has been shown and described in detail to illustrate the application of the principles of the invention, it will be understood that the invention may be embodied otherwise without departing from such principles.

What is claimed is:

1. A tracing and drawing case comprising:
a rear wall;
a frame attached to the rear wall;
a transparent cover encased within said frame;
a transparent game board interposed in between said rear wall and transparent cover, said board having recesses for receiving play pieces;
a slot between said transparent board and said rear wall; and
a traceable medium for displaying an image, insertable into said slot.

2. A tracing and drawing case according to claim 1, further comprising an easel back connected to the case for supporting the case in a vertical position.

3. A tracing and drawing case according to claim 1, wherein said play pieces are colored.

4. A tracing and drawing case according to claim 1, further comprising a handle for carrying said case vertically.

5. A tracing and drawing case according to claim 1, further comprising a locking means so that the play pieces do not fall out of the recesses of the game board.

6. A tracing and drawing toy for manipulating and arranging magnetic play pieces to trace an image comprising:
a case having a rear wall attached to a frame;
a transparent cover encased within the frame;
a transparent game board interposed between said rear wall and transparent cover; said board having recesses for receiving said play pieces;
a slot between said transparent board and said rear wall;
a medium for displaying said image, insertable into said slot;
a locking means so that the play pieces do not fall out of the recesses of the game board; and
a magnet means for manipulating and arranging magnetic play pieces to trace said image.

7. A tracing and drawing toy according to claim 6, wherein said play pieces are colored.

8. A tracing and drawing toy according to claim 6, further comprising a handle for carrying said case vertically.

9. A tracing and drawing toy according to claim 6, further comprising an easel for supporting and displaying said case.

10. A tracing and drawing toy according to claim 6, further comprising an easel back for supporting and displaying said case.
